(19) United States
(12) Patent Application Publication
(10) Pub. No.: US 2006/0083863 A1
(43) Pub. Date: Apr. 20, 2006

(54) Golf ball having sprayed layer of liquid polybutadiene

(76) Inventors: Christopher Cavallaro, Lakeville, MA (US); Matthew F. Hogge, New Bedford, MA (US); Michael D. Jordan, East Greenwich, RI (US)

Correspondence Address: ACUSHNET COMPANY, 333 BRIDGE STREET, P. O. BOX 965, FAIRHAVEN, MA, 02719, US

(21) Appl. No.: 10/967,874

(22) Filed: Oct. 18, 2004

(51) Int. Cl. B05D 3/02; B05D 1/36; B05D 1/02; B29C 71/04

(52) U.S. Cl. 427/421.1; 427/372.2; 427/402; 427/532

(57) ABSTRACT

A method of forming a golf ball, comprising spraying a thin layer of between about 0.001 inch to about 0.01 inch made from a rubber composition, wherein the rubber composition comprises liquid polybutadiene as the sole rubber component. The layer is cured by infrared radiation and increased layer thickness may be achieved by multiple sprayings oa the liquid polybutadiene. The molecular weight of the sprayable liquid polybutadiene is at least about 1,000 and the liquid polybutadiene is in a liquid state at room temperature.

### FIELD OF THE INVENTION

This invention relates generally to a method for forming golf balls, having at least a layer formed from spraying with liquid polybutadiene.

### BACKGROUND OF THE INVENTION

Conventional solid golf balls have primarily two functional components, i.e., the core and the cover. The primary purpose of the core is to be the “spring” of the ball or the principal source of resiliency. The primary purpose of the cover is to protect the core. Solid golf balls include two-piece balls and multi-layer balls. Multi-layer solid balls include multi-layer core constructions or multi-layer cover constructions, and combinations thereof. Two-piece solid balls are made with a single-solid core, usually a cross linked polybutadiene or rubber, which is encased by a hard cover material. The resiliency of the core can be increased by increasing the crosslink density of the core material. However, as the resiliency increases, the compression of the core may also increase, thus making the balls stiffer. Stiffness is a physical attribute defined by load per unit of deflection. In the golf ball art, stiffness is commonly measured using Atti and Rheile “compression” gauges; however, other methods can be used.

Different covers vary in the types of protection they provide, and different cores have different protection requirements. For example, polybutadiene cores in solid balls are adversely affected by moisture, and their covers should have good moisture barrier properties and should be applied to the cores soon after their formation. On the other hand, if a wound core is exposed to air, the windings may oxidize rapidly and lose their resiliency. As a result, wound balls require covers that protect them from oxidation.

A correlation has been observed between the stiffness of the cover and the resiliency of the ball. The stiff or hard ionomer covers can function as a hoop-stress layer providing both core protection and improved resilience. For example, U.S. Pat. No. 5,314,187 discloses a golf ball having a solid core, an inner cover made from an ionomer resin, and an outer cover made from a blend of balata and cross-linkable polybutadiene. However, the better a cover layer functions as a hoop-stress layer, the harder it feels and the worse it performs greenside.

The most common covers have been ionomers, such as SURLYN®, which is a tradename for a family of ionomer resins produced by E.I. DuPont de Nemours & Co. of Wilmington, Del. Recently, however, manufacturers have used alternative polymers, such as polyurethane. For example, U.S. Pat. No. 6,132,324 discloses to a method of making a golf ball having polyurethane cover. This patent is hereby incorporated by reference in its entireties. Polyurethanes have been recognized as useful materials for golf ball covers since about 1960. Polyurethane compositions are the product of a reaction between a curing agent and a polyurethane prepolymer, which is itself a product formed by a reaction between a polyol and a diisocyanate. The curing agents are typically diamines or glycols. A catalyst is often employed to promote the reaction between the curing agent and the polyurethane prepolymer.

Since 1960, various companies have investigated the usefulness of polyurethane as a golf ball cover material. The first commercially successful polyurethane covered golf balls were the Titleist® Professional®, which was released in 1993, and the Spalding Executive. Subsequently, the Titleist® Pro-V1® ball was introduced successfully in 2000 with a resilient solid polybutadiene core, a hard ionomer casing and a polyurethane cover. The Pro-V1 ball provided both professional and amateur players with long distance off of drivers and better control for greenside play.

A drawback from using polyurethane as the cover layer is that aromatic polyurethane lacks color stability when exposed to ultraviolet light. On the other hand, ionomer can be too rigid as a cover layer, which can negatively affect greenside play. Compression molded solid polybutadiene had been used in one-piece golf balls, and offered good durability. This polybutadiene also retained its appearance and durability after long term play. However, one-piece golf balls have been unable to achieve the performance characteristics required in high performance balls. Furthermore, the surface finish of compression molded polybutadiene is less aesthetically pleasing as polyurethane or ionomer covers.

For cores the most common polymer employed is polybutadiene, and more specifically, polybutadiene having a high cis-isomer concentration. In one example, U.S. Pat. No. 6,302,808 B1 discloses a ball comprising a core encased by an intermediate layer made from a three-layer composite and a cover. The core and the multi-layer intermediate layer are made from solid polybutadiene and provide improved playing characteristics such as spin and overall driving distance. Liquid polybutadiene has been used as a component in core or cover formulations. U.S. Pat. No. 5,096,201 discloses a golf ball composition, which includes solid rubber and a premix of cross-linking agents. The premix contains a liquid polymer, e.g., butadiene rubber, and an unsaturated fatty acid. U.S. Pat. No. 5,215,308 discloses a golf ball formulation that includes a base rubber, a cross-linking agent and an organic peroxide. The base rubber includes at least 40% of solid polybutadiene cis-1,4 isomer and a liquid polybutadiene and/or liquid polyisoprene. United States published patent application No. 2003/0073517 discloses a cover formulation, which includes an ionomer resin, a urethane material and a rubbery elastomer. The rubbery elastomer includes an elastomer and an optional polar-bearing compound, which can be liquid polybutadiene, among many other polymers.

However, the prior art does not disclose a golf ball having a layer made by spraying liquid polybutadiene about a golf ball sub-assembly.

### SUMMARY OF THE INVENTION

The present invention is directed to a method of making a golf ball having at least a layer formed by spraying liquid polybutadiene about a golf ball component.

The present invention is further directed to a method of forming a golf ball comprising one or more of the core layer(s), intermediate layer(s) or cover formed by sprayed liquid polybutadiene.

The present invention is directed to a method of forming a golf ball comprising a layer made from a rubber composition, wherein the rubber composition comprises a sprayed liquid polybutadiene as the sole rubber component, and wherein the molecular weight of the sprayed liquid polybutadiene is at least about 1,000, and wherein the sprayed liquid polybutadiene is in a liquid state at room temperature. The sprayable liquid preferably comprises less than 30% by weight of vinyl-1,2 isomer. The molecular weight is preferably at least 2,000 and more preferably at least 5,000.

The sprayable liquid polybutadiene can be functionalized with epoxy, (meth)acrylate, hydroxyl, vinyl, isocyanate, ester, carboxyl or carbonyl groups. The sprayable liquid polybutadiene is polymerized by ultraviolet light or photo-polymerization. The rubber component may also comprise a reactive co-agent, a cross-linking agent, a cis-to-trans catalyst and/or a free radical initiator.

The sprayable liquid polybutadiene layer can be an intermediate layer, a core or a cover. This layer can also be a water vapor barrier layer, and may contain fillers to alter properties of the layer. It may also encase a liquid filled or hollow core.

Exemplary golf balls made in accordance with the present invention are described in detail below.

### BRIEF DESCRIPTION OF THE DRAWINGS

FIG. 1 is a front view of a golf ball.

FIG. 2 is cross-sectional view of a first embodiment of golf ball 10 according to the present invention showing core 12, intermediate layer 14 and cover 16.

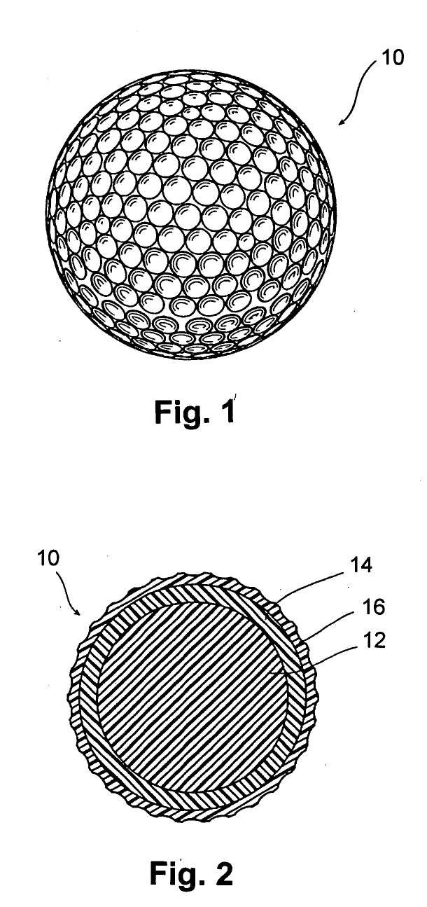

### DETAILED DESCRIPTION

In accordance to one aspect of the present invention, sprayable liquid polybutadiene compositions are used in making golf balls. These compositions have sprayable liquid polybutadiene as the base rubber. The liquid polybutadiene composition is sprayed over a golf ball component and reacted or cured to form a solid layer(s) in a golf ball. An advantage of using sprayable liquid polybutadiene includes the ability to form very thin layers, wherein thicknesses between about 0.010 to about 0.001 inch are possible. For thicker layers, the component may be sprayed multiple times to attain a desired thickness. A durable and aesthetically pleasing cover layer can also be formed on a golf ball by a sprayed liquid polybutadiene.

Liquid polybutadienes are low molecular weight polymers, which are clear liquids at room temperature and whose main chain has a microstructure composed of vinyl-1,2 isomer, trans-1,4 isomer and cis-1,4 isomer. Preferably, the vinyl-1,2 isomer content is less than 30% by weight to protect low temperature properties of the cast layer. The molecular weight of liquid polybutadiene is at least 1,000 and preferably at least 2,000 and more preferably at least 5,000. The preferred Brookfield viscosity of liquid polybutadiene is less than about 10,000 cp and more preferably less than about 1,000 cp.

Due to the unique polybutadiene backbone chemistry, thin films cured from this polymer have inherent hydrolytic stability, low temperature flexibility and low moisture permeability. It is also resistant to aqueous acids and bases. Liquid polybutadiene can be functionalized with epoxy, (meth)acrylate, hydroxyl, vinyl, isocyanate, ester, carboxyl and carbonyl groups. The epoxy and (meth)acrylate groups are preferred, because polymerization can be photo-induced by either free radical or cationic mechanism. Photo-polymerization, photo-curing or photo-crosslinking can be utilized in making thin films and coatings from liquid polyurethane. Infrared radiation can be used to create rapid curing gradients in the layers and quick drying of multiple layers.

Liquid polybutadienes are commercially available as (meth)acrylated liquid polybutadiene, epoxidized liquid polybutadiene, liquid polybutadiene dimethacrylate, and liquid polybutadiene urethane diacrylate from the Sartomer Company in Exton, Pa., under Ricacryl® and poly BD® tradenames. Liquid polybutadienes are also available: from the Nippon Oil Company as Nisseki Polybutadiene B-3000; from the Kuraray Company as Kuraray LIR-300; from the Idemitsu Petrochemical Company, Ltd, as R-45HT; and, from the Krasol Company as Krasol liquid polybutadiene; among others.

In one example, a (meth)acrylate functionalized liquid polybutadiene is sprayed to a uniform film thickness between about 0.01 inch to about 0.001 inch. The thin layer is then cured to crosslink the layer by using infrared radiation. The intensity and time of the infrared radiation can be calibrated to cure the entire thickness of the layer. The cured film exhibits superior hydrolytic stability and low transmission to water vapor. Cured thin films of liquid polybutadiene are also resistant to aqueous acidic and basic solutions. Equipment for applying the sprayable polybutadiene is well known in the art. The equipment used for spraying the ball component of the present invention can involve passing the component through a plurality of spray guns which issue multiple streams of liquid polybutadiene to completely cover the component. Tandem ovens may also be used with equal effectiveness. In the spraying process very thin layers of uniform thickness are created which may be cured quickly by IR or convective IR. The cured layers serve several purposes: as a compression gradient to reduce spin; as a sacrificial moisture absorption layer; as a highly filled (torturous path) moisture barrier; as a moment of inertia adjuster; as an inner cover or as an outer cover. While single pass sprayed layers have thicknesses between about 0.01 inch and 0.001 inch, increased thickness may be attained by passing the golf ball component through the spray and cure processes multiple times.

Water vapor barrier layer 14 resists the encroachment of water vapor into the inner core 12. Solid polybutadiene, the most commonly used polymer in golf ball cores, when cross-linked with peroxide and/or zinc diacrylate is susceptible to having its resilience degraded by encroaching water vapor. Water vapor barrier layer 14 preferably has a moisture vapor transmission rate lower than that of cover 16, and may include nano particles, flaked-metals, such as mica, iron oxide and aluminum, or ceramic particles blended therein to provide a tortuous path to water encroachment. Water vapor barrier layer 14 is fully disclosed in U.S. Pat. No. 6,632,147, and this commonly owned patent is incorporated by reference herein in its entirety.

Polybutadiene used in golf balls typically incorporates at least one reactive co-agent to enhance their hardness. Suitable co-agents for use in this invention may be selected from an unsaturated carboxylic acid or an unsaturated vinyl compound. For liquid polybutadiene, the preferred reactive co-agent is an unsaturated vinyl compound. A preferred unsaturated vinyl is trimethylolpropane trimethacrylate, commercially available as SR-350 from Sartomer. Trimethylolpropane trimethacrylate is particularly suitable because it is a clear liquid at room temperature and can be readily mixed with the liquid polybutadiene.

A cross-linking agent is included to increase the hardness of the reaction product. Suitable cross-linking agents include one or more metallic salts of unsaturated fatty acids or monocarboxylic acids, such as zinc, aluminum, sodium, lithium, nickel, calcium, or magnesium acrylate salts, and the like, and mixtures thereof. Preferred acrylates include zinc acrylate, zinc diacrylate, zinc methacrylate, and zinc dimethacrylate, and mixtures thereof. The cross-linking agent must be present in an amount sufficient to crosslink a portion of the chains of polymers in the resilient polymer component. For example, the desired compression may be obtained by adjusting the amount of cross-linking. This may be achieved, for example, by altering the type and amount of cross-linking agent, a method well-known to those of ordinary skill in the art. The cross-linking agent is typically present in an amount greater than about 0.1 percent of the resilient polymer component, i.e., the sprayable liquid polybutadiene, preferably from about 10 to 40 percent of the resilient polymer component, more preferably from about 10 to 30 percent of the resilient polymer component. When an organosulfur is selected as the cis-to-trans catalyst, zinc diacrylate may be selected as the cross-linking agent and is preferably present in an amount of less than about 40 phr. Suitable, commercially available, zinc diacrylates include those from the Sartomer Corporation. Zinc diacrylate is available in solid powder form that can be suspended in the liquid reactive co-agent, such as trimethylolpropane trimethacrylate, to be cross-linked with sprayable liquid polybutadiene.

As used herein, the term “parts per hundred,” also known as “phr,” is defined as the number of parts by weight of a particular component present in a mixture, relative to 100 parts by weight of the total polymer component. Mathematically, this can be expressed as the weight of an ingredient divided by the total weight of the polymer, multiplied by a factor of 100. In the present invention the polymer component is sprayable liquid polybutadiene.

A free radical initiator can be used to promote the crosslink reaction between reactive co-agent and polybutadiene. The free radical initiators may be any known polymerization initiators that decompose during the curing cycle. Suitable initiators include peroxides. Examples of the peroxides for the purposes of the present invention include dicumyl peroxide; n-butyl-4,4-di(t-butylperoxy)-valerate; 1,1-bis(t-butylperoxy)-3,3,5-trimethylcyclohexane; α,α′-bis(t-butylperoxy)-diisopropylbenzene; 2,5-dimethyl-2,5-di(t-butylperoxy)hexane; di-t-butyl peroxide; di-t-amyl peroxide; di(2-t-butyl-peroxyisopropyl)benzene peroxide; lauryl peroxide; benzoyl peroxide; t-butyl hydroperoxide; and mixtures thereof. Preferably, the peroxide initiator is dicumyl peroxide having an activity between about 40% and about 100%. Also preferably, the initiator is present in the polybutadiene blend in an amount ranging between about 0.05 phr and about 15 phr by weight of polybutadiene. More preferably, the amount of the initiator ranges between about 0.1 phr and about 5 phr, and most preferably between about 0.25 and about 1.5 phr. Preferably, the peroxide selected is in liquid form. The amount of peroxide used should be measured to prohibit premature reaction.

In accordance to another aspect of the present invention, radical scavengers are added to the polybutadiene to act as molecular weight adjusters. Preferred radical scavengers include sulfur compounds, such as halogenated organo-sulfur compound that can be blended with liquid polybutadiene. Halogenated organo-sulfur compounds include organic compounds wherein at least one sulfur compound is added to the polybutadiene to increase the resiliency and the coefficient of restitution of the ball. Preferred sulfur compounds include, but are not limited to, pentachlorothiophenol (PCTP) and a salt of PCTP. A preferred salt of PCTP is ZnPCTP. The utilization of PCTP and ZnPCTP in golf ball inner cores to produce soft and fast inner cores is fully disclosed in U.S. Pat. No. 6,635,716, which is incorporated by reference in its entirety. A suitable PCTP is sold by the Structol Company under the tradename A95. ZnPCTP is commercially available from EchinaChem. Other suitable radical scavengers include 0,0′-dibenzamidodi-phenyldisulfide. Other molecular weight adjusters are disclosed in U.S. Pat. No. 4,722,977, which is incorporated herein by reference in its entirety.

In one example, core 12 is a conventional core made with solid polybutadiene as the primary rubber component. Preferably, the core has a diameter from about 1.50 inches to about 1.62 inches, more preferably from about 1.55 inches to about 1.60 inches, and most preferably from about 1.55 inches to about 1.58 inches. An intermediate layer 14 is sprayed over the core 12 from liquid polybutadiene in accordance with the present invention. Preferably, intermediate layer 14 has a thickness from about 0.01 inch to about 0.05 inch, more preferably from about 0.02 inch to about 0.04 inch, and most preferably from about 0.03 inch. Cover 16 can be made from ionomers, ionomer and metallocene catalyzed polymer blends, polyurea or polyurethane. Suitable metallocene catalyzed polymers and blends thereof are disclosed U.S. Pat. Nos. 5,703,166 and 5,824,746, among others. These references are incorporated herein by reference in their entireties.

In another example, core 12 is substantially the same as the core in the preceding example, and cover 16 is formed by spraying liquid polybutadiene over the core 12 in accordance with the present invention. Preferably, cover 16 has a thickness in the range of about 0.01 inch to about 0.1 inch, and more preferably in the range of 0.03 inch to about 0.05 inch. Cover 16 preferably contains 100 phr of liquid polybutadiene, 15-40 phr of zinc diacrylate (ZDA), 0.1-1 phr of ZnPCTP and titanium dioxide fillers. The more preferred range of ZDA is about 15 to about 25 phr, and the more preferred range of ZnPCTP is greater than 0.3 phr.

In another example, core 12 is substantially the same as the core in the preceding examples. Intermediate layer 14 is an inner cover made from thermoplastic polymers, such as those described in U.S. Pat. Nos. 5,885,172 and 6,486,261. Cover 16 is made from the same materials and has the same dimensions as the preceding example.

The sprayable liquid polybutadiene compositions of the present invention may also include fillers, added to the polybutadiene material to adjust the density and/or specific gravity of the core or to the cover. As used herein, the term “fillers” includes any compound or composition that can be used to adjust the density and/or other properties of the subject golf ball core. Fillers useful in the golf ball core according to the present invention include, for example, zinc oxide, barium sulfate, flakes, fibers, and regrind, which is ground, recycled core material (for example, ground to about 30 mesh particle size). The amount and type of filler utilized is governed by the amount and weight of other ingredients in the composition, since a maximum golf ball weight of 45.93 g (1.62 ounces) has been established by the United States Golf Association (USGA). Appropriate fillers generally used have a specific gravity from about 2 to 20. In one preferred embodiment, the specific gravity can be about 2 to 6.

Fillers are typically polymeric or mineral particles. Exemplary fillers include precipitated hydrated silica; clay; talc; asbestos; glass fibers; aramid fibers; mica; calcium metasilicate; barium sulfate; zinc sulfide; lithopone; silicates; silicon carbide; diatomaceous earth; polyvinyl chloride; carbonates such as calcium carbonate and magnesium carbonate; metals such as titanium, tungsten, aluminum, bismuth, nickel, molybdenum, iron, lead, copper, boron, cobalt, beryllium, zinc, and tin; metal alloys such as steel, brass, bronze, boron carbide whiskers, and tungsten carbide whiskers; metal oxides such as zinc oxide, iron oxide, aluminum oxide, titanium oxide, magnesium oxide, and zirconium oxide; particulate carbonaceous materials such as graphite, carbon black, cotton flock, natural bitumen, cellulose flock, and leather fiber; micro balloons such as glass and ceramic; fly ash; and combinations thereof.

In one example, the sprayed liquid polybutadiene layer may also include high density metal or metal alloy powder fillers to increase the rotational moment of inertia of the golf ball to reduce spin. Since the polymer is in liquid form, fillers can easily be mixed or blended to the polymer. High moment of rotational inertia is disclosed in commonly owned U.S. Pat. No. 6,494,795, which is incorporated herein by reference in its entirety. Preferably, the specific gravity of the filled sprayed liquid polybutadiene layer is greater than about 1.5, more preferably greater than about 2.5 and most preferably greater than about 5.0.

The sprayed liquid polybutadiene layer may also include filler or fibers that alter the flexural modulus or the hardness of the layer.

Sprayable liquid polybutadiene is stable when exposed to UV light, so that a sprayed liquid polybutadiene cover does not change color during its useful playing life. Polybutadiene covers can be durable as shown by the demonstrated durability of one-piece polybutadiene range balls. The spraying process discussed above can also be used to spray liquid polybutadiene as a cover layer.

Other liquid rubber polymers, such as liquid polyisoprene, liquid butadiene-isoprene copolymers, liquid polybutene, or the like and combination thereof, can be substituted for liquid polybutadiene.

While it is apparent that the illustrative embodiments of the invention herein disclosed fulfills the objectives stated above, it will be appreciated that numerous modifications and other embodiments may be devised by those of ordinary skill in the art. Therefore, it will be understood that the appended claims are intended to cover all such modifications and embodiments which come within the spirit and scope of the present invention.

What is claimed is:

1. A method for forming a layer on a golf ball comprising the steps of:
providing a golf ball component;
providing a rubber composition comprised of liquid polybutadiene that is in a liquid state at room temperture and has having a molecular weight at least about 1,000;
spraying the liquid polybutadiene on the golf ball component to create a thin layer having a thickness of between about 0.001 inch to about 0.07 inch;
curing the layer;
spraying a water vapor barrier layer on the thin layer; and
forming a cover over the water vapor barrier layer.

2. The method of claim 1, wherein the golf ball component is a solid core, a fluid-filled core, an outer core layer, an intermediate layer or an inner cover layer.

3. The method of claim 1, wherein the step of providing the liquid polybutadiene comprises functionalizing it with a group selected from a list consisting of epoxy, (meth)acrylate, hydroxyl, vinyl, isocyanate, ester, carboxyl and carbonyl groups.

4. The method of claim 1, wherein the curing step comprises exposing the thin layer to infrared radiation.

5. The method of claim 1, wherein the step of providing the rubber composition further comprises the step of blending the liquid polybutadiene with a reactive co-agent.

6. The method of claim 5, wherein the reactive co-agent comprises an unsaturated carboxylic acid.

7. The method of claim 5, wherein the reactive co-agent comprises an unsaturated vinyl compound.

8. The method of claim 7, wherein the unsaturated vinyl compound is trimethylolpropane trimethacrylate.

9. The method of claim 1, wherein the step of providing the rubber composition further comprises blending the liquid polybutadiene with a free radical initiator comprising peroxide.

10. The method of claim 1, wherein the step of providing the rubber composition further comprises blending the liquid polybutadiene with a molecular weight adjusting compound.

11. The method of claim 10, wherein the molecular weight adjusting compound comprises an organo-sulfur compound.

12. The method of claim 11, wherein the organo-sulfur compound comprises pentachlorothiophenol.

13. The method of claim 11, wherein the organosulfur comprises zinc pentachlorothiophenol.

14. The method of claim 1, wherein the step of providing the rubber composition further includes blending the liquid polybutadiene with a cross-linking agent.

15. The method of claim 14, wherein the cross-linking agent comprises one or more metallic salts of unsaturated fatty acids or monocarboxylic acids.

16. The method of claim 14, wherein the cross-linking agent is selected from a group consisting of zinc, aluminum, sodium, lithium, nickel, calcium, magnesium, acrylate salt and mixtures thereof.

17. The method of claim 16, wherein the acrylate salt is selected from a group consisting of zinc acrylate, zinc diacrylate, zinc methacrylate, zinc dimethacrylate, and mixtures thereof.

18. The method of claim 2, wherein the golf ball includes an intermediate layer having a thickness in the range of about 0.01 inch to about 0.05 inch.

19. The method of claim 18, wherein the intermediate layer thickness is in the range of about 0.02 inch to about 0.04 inch.

20. The method of claim 18, wherein the thickness is in the range of about 0.03 inch.

21. The method of claim 2, wherein the golf ball includes a solid core having a diameter of about 1.50 inches to about 1.62 inches.

22. The method of claim 2, wherein the cover has a thickness of about 0.01 to about 0.1 inch.

23. The golf ball of claim 2, wherein the cover has a thickness of about 0.03 inch to about 0.05 inch.

24. The golf ball of claim 1, wherein the rubber composition has a Brookfield viscosity of less than about 10,000 cp at room temperature.

25. The golf ball of claim 34, wherein the rubber composition has a Brookfield viscosity of less than about 1,000 cp at room temperature.
